(19) United States
(12) Patent Application Publication
(10) Pub. No.: US 2026/0094072 A1
(43) Pub. Date: Apr. 2, 2026

(54) METHOD AND SYSTEM OF MITIGATING PREDICTIVE MULTIPLICITY IN A GRADIENT BOOSTING MODEL

(71) Applicant: JPMorgan Chase Bank, N.A., New York, NY (US)

(72) Inventors: Ivan BRUGERE, Des Plaines, IL (US); Hsiang HSU, Boston, MA (US); Shubham SHARMA, Manhattan, NY (US); Freddy LECUE, Mamaroneck, NY (US); Richard CHEN, Baldwin Place, NY (US)

(73) Assignee: JPMorgan Chase Bank, N.A., New York, NY (US)

(21) Appl. No.: 18/902,210

(22) Filed: Sep. 30, 2024

(51) Int. Cl. G06N 20/20

(52) U.S. Cl. CPC G06N 20/20

(57) ABSTRACT

A method and system for mitigating predictive multiplicity in a gradient boosting model (GBM). The method includes generating an empirical parameter set based on an approximation search resulting in a subset that includes candidates of at least one weak learner model (WLM) from a predetermined set of WLMs and training iteratively the empirical parameter set to derive a group filtered from the subset based on at least one from among a model selection (MS) technique and an intermediate ensembles (IE) technique. The method also includes selecting sequentially the at least one WLM from the derived group based on the at least one from among the MS technique and the IE technique; and generating the GBM based on a compilation of the sequentially selected at least one WLM, wherein the generated GBM operates below a minimum predefined disagreement threshold related to assessing predictive multiplicity, thereby mitigating the predictive multiplicity.

### BACKGROUND

### 1. Field of the Disclosure

This technology generally relates to methods and systems of mitigating predictive multiplicity in a gradient boosting model (GBM).

### 2. Background Information

Large-scale, complex data, and the pursuit of superior performance in machine learning (ML) models have led to increased complexity in both the ML models themselves and the training algorithms. As a result, it is more likely to find a plethora of distinct models, such as those found in local minima, that exhibit statistically indistinguishable performance (e.g., test accuracy). This phenomenon, known as the Rashomon effect, has urged researchers to reconsider its impact on ML models when deployed in real-world scenarios.

The Rashomon effect can enhance the prospects of finding ML models that perform well in accuracy while adhering to ethical standards, such as fairness or interpretability. However, it also poses a risk to the credibility of machine decisions through a phenomenon wherein comparable models in aggregate performance (e.g., test accuracy) produces different individual outcomes for a data point. This phenomenon may be known as predictive multiplicity. While research and studies in the status quo has explored the Rashomon effect across various ML algorithms, its impact on gradient boosting, an ML algorithm widely applied to tabular datasets, remains unclear and have not been researched and studied despite gradient boosting model (GBM) being frequently used.

That is, presently within the status quo, recent studies seeking to understand the Rashomon effect and address predictive multiplicity have focused on characterizing competing models and efficiently searching for them across different ML models. However, there have not been studies regarding the Rashomon effect and GBMs.

Accordingly, there is a need for techniques to mitigate predictive multiplicity in GBM.

### SUMMARY

The present disclosure, through one or more of its various aspects, embodiments, and/or specific features or sub-components, provides, inter alia, various systems, servers, devices, methods, media, programs, and platforms for mitigating predictive multiplicity in a gradient boosting model (GBM).

According to an aspect of the present disclosure, a method of mitigating predictive multiplicity in a gradient boosting model (GBM) is provided. The method may be implemented by at least one processor. The method may include: generating an empirical parameter set based on an approximation search related to a full parameter set resulting in a subset that may include candidates of at least one weak learner model (WLM) from a predetermined set of WLMs; training iteratively the empirical parameter set to derive a group filtered from the subset based on at least one from among a model selection (MS) technique via reweighted loss and an aggregation technique via an intermediate ensembles (IE) technique, wherein the group may include the at least one WLM operating with at least one from among a minimal error from the subset and an additive weighted sum; selecting sequentially the at least one WLM from the derived group based on the at least one from among the MS technique and the IE technique; and generating the GBM based on a compilation of the sequentially selected at least one WLM, wherein the generated GBM operates below a minimum predefined disagreement threshold related to assessing predictive multiplicity, thereby mitigating the predictive multiplicity in the GBM.

The MS technique may include: computing the reweighted loss for each of the at least one WLM within the subset, wherein the reweighted loss may include a predefined loss function evaluated at a data sample for the each of the at least one WLM and evaluated at a predefined mean loss function; generating the derived group that collectively operates with a minimum error as indicated by a minimum value of the computed reweighted loss; and choosing the at least one WLM from the derived group, wherein the chosen at least one WLM individually operates with the minimum value of the computed reweighted loss as compared with other WLMs within the derived group.

The MS technique may further include: computing residuals for a next training iteration based on the chosen at least one WLM; and returning the derived group at a last gradient boosting iteration of the training iteration.

The IE technique may include: constructing at least one weighted ensemble of WLMs based on randomly selecting the at least one WLM from the subset at each of the training iterations; computing an additive weighted sum of the at least one weighted ensemble of WLM based on at least one output from the randomly selected at least one WLM; and generating the derived group based on the computed additive weighted sum.

The full parameter set may include a Rashomon set that may include the predetermined set of WLMs within a hypothesis space with population risks associated with that of a predefined empirical risk minimizer.

The generating the empirical parameter set may include approximating the Rashomon set with the subset from the predetermined set of WLMs within the hypothesis space. The empirical parameter set may denote an empirical Rashomon set.

The minimum predefined disagreement threshold may include a predefined p-disagreement function with a p value of zero.

The method may further include expanding the iterative training to the predetermined set of WLMs.

According to another embodiment, a computing apparatus for mitigating predictive multiplicity in a gradient boosting model (GBM) may be provided. The computing apparatus may include: a processor; a memory; a display; and a communication interface coupled to each of the processor, the memory, and the display.

The processor may be configured to: generate an empirical parameter set based on an approximation search related to a full parameter set resulting in a subset comprising candidates of at least one weak learner model (WLM) from a predetermined set of WLMs; train iteratively the empirical parameter set to derive a group filtered from the subset based on at least one from among a model selection (MS) technique via reweighted loss and an aggregation technique via an intermediate ensembles (IE) technique, wherein the group comprises the at least one WLM operating with at least one from among a minimal error from the subset and an additive weighted sum; select sequentially the at least one WLM from the derived group based on the at least one from among the MS technique and the IE technique; and generate the GBM based on a compilation of the sequentially selected at least one WLM, wherein the generated GBM operates below a minimum predefined disagreement threshold related to assessing predictive multiplicity, thereby mitigating the predictive multiplicity in the GBM.

The MS technique may include: computing the reweighted loss for each of the at least one WLM within the subset, wherein the reweighted loss comprises a predefined loss function evaluated at a data sample for the each of the at least one WLM and evaluated at a predefined mean loss function; generating the derived group that collectively operates with a minimum error as indicated by a minimum value of the computed reweighted loss; and choosing the at least one WLM from the derived group, wherein the chosen at least one WLM individually operates with the minimum value of the computed reweighted loss as compared with other WLMs within the derived group.

The MS technique may further include: computing residuals for a next training iteration based on the chosen at least one WLM; and returning the derived group at a last gradient boosting iteration of the training iteration.

The IE technique may include: constructing at least one weighted ensemble of WLMs based on randomly selecting the at least one WLM from the subset at each of the training iterations; computing an additive weighted sum of the at least one weighted ensemble of WLM based on at least one output from the randomly selected at least one WLM; and generating the derived group based on the computed additive weighted sum.

The full parameter set may include a Rashomon set that may include the predetermined set of WLMs within a hypothesis space with population risks associated with that of a predefined empirical risk minimizer. The generating the empirical parameter set comprises approximating the Rashomon set with the subset from the predetermined set of WLMs within the hypothesis space. The empirical parameter set may denote an empirical Rashomon set. The minimum predefined disagreement threshold comprises a predefined p-disagreement function with a p value of zero.

The processor may be further configured to expand the iterative training to the predetermined set of WLMs.

According to yet another embodiment, non-transitory computer readable storage medium storing instructions for mitigating predictive multiplicity in a gradient boosting model (GBM) is provided. The non-transitory computer readable storage medium comprising executable code which, when executed by a processor, may cause the processor to: generate an empirical parameter set based on an approximation search related to a full parameter set resulting in a subset comprising candidates of at least one weak learner model (WLM) from a predetermined set of WLMs; train iteratively the empirical parameter set to derive a group filtered from the subset based on at least one from among a model selection (MS) technique via reweighted loss and an aggregation technique via an intermediate ensembles (IE) technique, wherein the group may include the at least one WLM operating with at least one from among a minimal error from the subset and an additive weighted sum; select sequentially the at least one WLM from the derived group based on the at least one from among the MS technique and the IE technique; and generate the GBM based on a compilation of the sequentially selected at least one WLM, wherein the generated GBM operates below a minimum predefined disagreement threshold related to assessing predictive multiplicity, thereby mitigating the predictive multiplicity in the GBM.

The MS technique may include: computing the reweighted loss for each of the at least one WLM within the subset, wherein the reweighted loss may include a predefined loss function evaluated at a data sample for the each of the at least one WLM and evaluated at a predefined mean loss function; generating the derived group that collectively operates with a minimum error as indicated by a minimum value of the computed reweighted loss; and choosing the at least one WLM from the derived group, wherein the chosen at least one WLM individually operates with the minimum value of the computed reweighted loss as compared with other WLMs within the derived group.

The MS technique further may include: computing residuals for a next training iteration based on the chosen at least one WLM; and returning the derived group at a last gradient boosting iteration of the training iteration.

The IE technique may include: constructing at least one weighted ensemble of WLMs based on randomly selecting the at least one WLM from the subset at each of the training iterations; computing an additive weighted sum of the at least one weighted ensemble of WLM based on at least one output from the randomly selected at least one WLM; and generating the derived group based on the computed additive weighted sum.

The full parameter set may include a Rashomon set that may include the predetermined set of WLMs within a hypothesis space with population risks associated with that of a predefined empirical risk minimizer. The generating the empirical parameter set may include approximating the Rashomon set with the subset from the predetermined set of WLMs within the hypothesis space. The empirical parameter set may denote an empirical Rashomon set.

The non-transitory computer readable storage medium may further cause the processor to expand the iterative training to the predetermined set of WLMs.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a system diagram of a computer system.

FIG. 2 illustrates a network diagram of a network environment.

FIG. 3 illustrates a diagram of a system environment according to an embodiment for mitigating predictive multiplicity in a gradient boosting model (GBM).

FIG. 4 illustrates a flowchart of a process diagram according to an embodiment for mitigating predictive multiplicity in a GBM.

FIG. 5 illustrates an example graph of a delta-zero disagreement of mitigating predictive multiplicity in a GBM based on a model selection (MS) technique according to an embodiment.

FIG. 6 illustrates an example graph of a delta-zero disagreement of mitigating predictive multiplicity in a GBM based on an intermediate ensembles (IE) technique according to an embodiment.

FIG. 7 illustrates an example composition of the GBM and its training procedure.

FIG. 8 illustrates an example training procedure of the weak learner models (WLMs) involving a MS technique.

FIG. 9 illustrates a continuation of the example training procedure of the WLMs involving the MS technique.

FIG. 10 illustrates an example training procedure of the WLMs involving the IE technique.

FIG. 11 illustrates a continuation of the example training procedure of the WLMs involving the IE technique.

FIG. 12 illustrates an example training procedure for multiple GBMs.

### DETAILED DESCRIPTION

With the presence of large-scale, complex data and the pursuit of superior performance in machine learning (ML) models have led to increased complexity in both the models themselves and the training algorithms. As a result, it is more likely to find a plethora of distinct models, such as those found in local minima, that exhibit statistically indistinguishable performance (e.g., test accuracy). That is, despite the fact that the ML models are distinct (i.e., different ML models), the performance of these ML models may achieve a similar loss for a given task. This phenomenon is known as the Rashomon effect.

The Rashomon effect reveals two sides of the same coin. On one hand, it benefits the current trend of developing algorithms that prioritize responsible ML principles beyond merely optimizing for accuracy. These principles often include interpretability, causality, group fairness, counterfactual explanations, and feature interactions. The abundance of models with competing performance allows compliance with these principles without significant compromises in performance.

On the other hand, the Rashomon effect presents a risk to the credibility of ML decisions known as predictive multiplicity, wherein competing ML models, generated by simply varying randomness in the training processes, yield conflicting predictions for some individual samples. That is, predictive multiplicity denotes a phenomenon wherein comparable models (e.g., ML models) in aggregate performance (e.g., test accuracy) produces different individual outcomes for a data point. The conflicting predictions may lead to discrimination and unfairness in critical opportunities for individual ML models, and have been recently studied under various guises such as prediction uncertainty, predictive churn, and predictive multiplicity. Note that Both prediction uncertainty and predictive multiplicity consider the arbitrariness of ML outputs, with predictive multiplicity specifically addressing ML models with competing performance. Predictive churn, on the other hand, focuses on the instability of decisions before and after updating the ML models with new data.

The present application addresses these limitations in the status quo by mitigating predictive multiplicity in a gradient boosting model (GBM) as described below. Notably, the present application focuses on GBM, which is a type of ML model algorithm that is widely applied to tabular datasets.

Gradient boosting differs fundamentally from other ML algorithms in its sequential approach, i.e., rather than training a model as a single entity, gradient boosting breaks down the training process into a sequence of sub-learning problems. This sequential training pipeline not only facilitates the analysis of the Rashomon effect but also offers new methodologies for model selection and reducing predictive multiplicity. The present application discloses techniques to mitigate predictive multiplicity for gradient boosting and experimentally validates the techniques on, e.g., tabular datasets. That is, the present application discloses techniques mitigates the generation of conflicting predictions for some individual samples in gradient boosting models (GBMs) due to the varying randomness in the training processes. The present application provides a technological improvement of the status quo because the status quo does not address mitigation of predictive multiplicity in GBMs. In contrast, the present application describes techniques for mitigating predictive multiplicity in GBMs. Specifically, the particular mitigation techniques involving model selection (MS) and intermediate ensembles (IE) techniques as described in the present application for mitigating predictive multiplicity in GBMs.

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

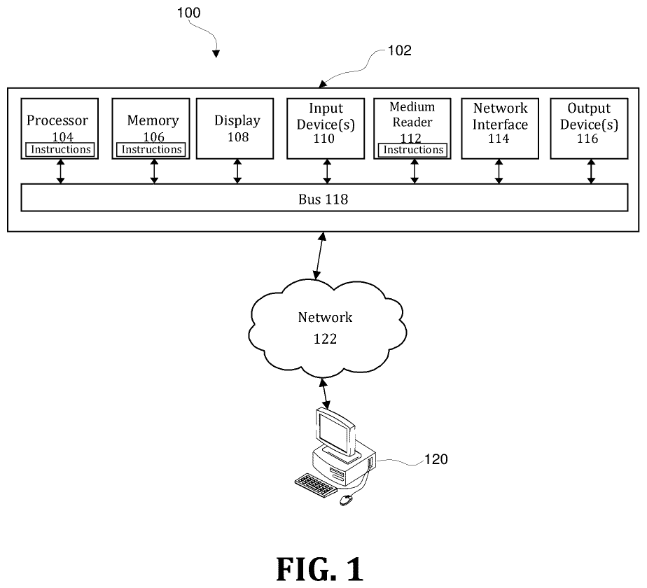

FIG. 1 illustrates a system 100 diagram of a computer system 102 for use in accordance with the embodiments described herein. The system 100 may be generally shown and may include a computer system 102, which may be generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 may be illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, digital optical disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but not limited to, a local area network, a wide area network, the Internet, a telephony network, a short-range network, or any other network commonly known and understood in the art. The short-range network may include, for example, short-range wireless technology standard used for exchanging data between fixed devices and mobile devices over short distances, low-power wireless ad-hoc mesh networks for linking together, infrared, near field communication, ultra-wideband, or any combination thereof. Those skilled in the art appreciate that additional networks 122 which are known and understood may additionally or alternatively be used and that the networks 122 are not limiting or exhaustive. Also, while the network 122 may be illustrated in FIG. 1 as a wireless network, those skilled in the art appreciate that the network 122 may also be a wired network.

The additional computer device 120 may be illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely examples of devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be examples and are not intended to be exhaustive and/or inclusive. Furthermore, the examples of the components listed above are also similarly not meant to be exhaustive and/or inclusive.

In accordance with various embodiments of the present disclosure, the methods described herein may be implemented using a hardware computer system that executes software programs. Further, in a non-limiting embodiment, implementations may include distributed processing, component/object distributed processing, and parallel processing. Virtual computer system processing may be constructed to implement one or more of the methods or functionalities as described herein, and a processor described herein may be used to support a virtual processing environment.

As described herein, various embodiments provide optimized methods and systems for mitigating predictive multiplicity in a gradient boosting model (GBM).

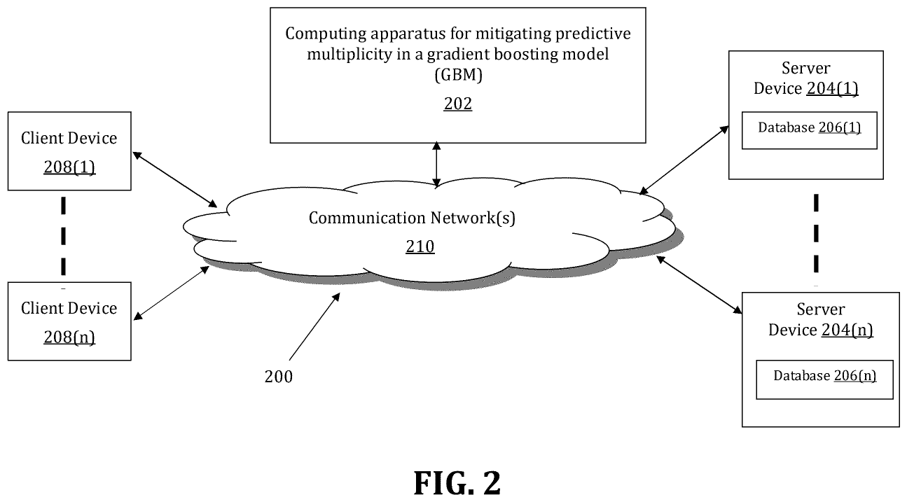

Referring to FIG. 2, a network diagram of a network environment 200 for mitigating predictive multiplicity in a gradient boosting model (GBM) may be illustrated. In an embodiment, the method may be executable on any networked computer platform, such as, for example, a personal computer (PC).

The method of mitigating predictive multiplicity in a gradient boosting model (GBM) may be implemented by a computing apparatus 202 that implements mitigating predictive multiplicity in a GBM. The computing apparatus 202 may be the same or similar to the computer system 102 as described with respect to FIG. 1. The computing apparatus 202 may store one or more applications that may include executable instructions that, when executed by the computing apparatus 202, cause the computing apparatus 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s) may be located in virtual server(s) running in a cloud-based computing environment rather than being tied to one or more specific physical network computing devices. Also, the application(s) may be running in one or more virtual machines (VMs) executing on the computing apparatus 202. Additionally, in one or more embodiments of this technology, virtual machine(s) running on the computing apparatus 202 may be managed or supervised by a hypervisor.

In the network environment 200 of FIG. 2, the computing apparatus 202 may be coupled to a plurality of server devices 204(1)-204(n) that hosts a plurality of databases 206(1)-206(n), and also to a plurality of client devices 208(1)-208(n) via communication network(s) 210. A communication interface of the computing apparatus 202, such as the network interface 114 of the computer system 102 of FIG. 1, operatively couples and communicates between the computing apparatus 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used. The server devices 204(1)-204(n) and/or the client devices 208(1)-208(n) may provide different computing environments.

The communication network(s) 210 may be the same or similar to the network 122 as described with respect to FIG. 1, although the computing apparatus 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and computing apparatus that efficiently implement a method of mitigating predictive multiplicity in a GBM.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, for example, tele-traffic in any suitable form (e.g., voice, modem, and the like), Public Switched Telephone Network (PSTNs), Ethernet-based Packet Data Networks (PDNs), combinations thereof, and the like.

The computing apparatus 202 may be a standalone device or integrated with one or more other devices or apparatuses, such as one or more of the server devices 204(1)-204(n), for example. In one particular example, the computing apparatus 202 may include or be hosted by one of the server devices 204(1)-204(n), and other arrangements are also possible. Moreover, one or more of the devices of the computing apparatus 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the computing apparatus 202 via the communication network(s) 210 according to the HTTP-based and/or script object notation protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that may interact with the computing apparatus 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 208 may be a wireless mobile communication device, i.e., a smart phone.

The client devices 208(1)-208(n) may run interface applications, such as standard web browsers or standalone client applications, which may provide an interface to communicate with the computing apparatus 202 via the communication network(s) 210 in order to communicate user requests and information. The client devices 208(1)-208(n) may further include, among other features, a display device, such as a display screen or touchscreen, and/or an input device, such as a keyboard, for example.

Although the network environment 200 with the computing apparatus 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems described herein are for example purposes, as many variations of the specific hardware and software used to implement the examples are possible, as will be appreciated by those skilled in the relevant art(s).

One or more of the devices depicted in the network environment 200, such as the computing apparatus 202, the server devices 204(1)-204(n), or the client devices 208(1)-208(n), for example, may be configured to operate as a virtual instance on the same physical machine. In other words, one or more of the computing apparatus 202, the server devices 204(1)-204(n), or the client devices 208(1)-208(n) may operate on the same physical device rather than as separate devices communicating through communication network(s) 210. Additionally, there may be more or fewer computing apparatus 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only tele-traffic in any suitable form (e.g., voice and modem), wireless traffic networks, cellular traffic networks, Packet Data Networks (PDNs), the Internet, intranets, and combinations thereof.

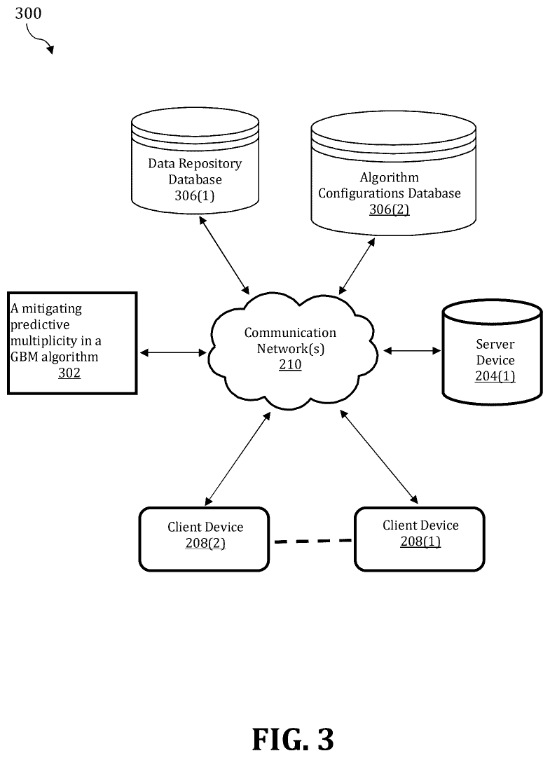

The computing apparatus 202 may be described and illustrated in FIG. 3 as may include a mitigating predictive multiplicity in a GBM algorithm 302, although it may include other rules, algorithms, policies, modules, databases, or applications, for example. As will be described below, the mitigating predictive multiplicity in the GBM algorithm 302 may be configured to implement a method of mitigating predictive multiplicity in a GBM.

FIG. 3 illustrates a diagram of a system environment 300 for implementing a method of mitigating predictive multiplicity in a GBM by utilizing the network environment of FIG. 2, which may be illustrated as being executed in FIG. 3. Specifically, a first client device 208(1) and a second client device 208(2) are illustrated as being in communication with computing apparatus 202. In this regard, the first client device 208(1) and the second client device 208(2) may be “clients” of the computing apparatus 202 and are described herein as such. Nevertheless, it is to be known and understood that the first client device 208(1) and/or the second client device 208(2) need not necessarily be “clients” of the computing apparatus 202, or any entity described in association therewith herein. Any additional or alternative relationship may exist between either or both of the first client device 208(1) and the second client device 208(2) and the computing apparatus 202, or no relationship may exist.

Further, computing apparatus 202 may be illustrated as being able to access a data repository database 306(1) and an algorithm configurations database 306(2). The mitigating predictive multiplicity in a GBM algorithm 302 may be configured to access these databases for implementing the mitigating predictive multiplicity in a GBM.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an embodiment, either or both of the first client device 208(1) and the second client device 208(2) may communicate with the computing apparatus 202 via broadband or cellular communication. Of course, these embodiments are merely examples and are not limiting or exhaustive.

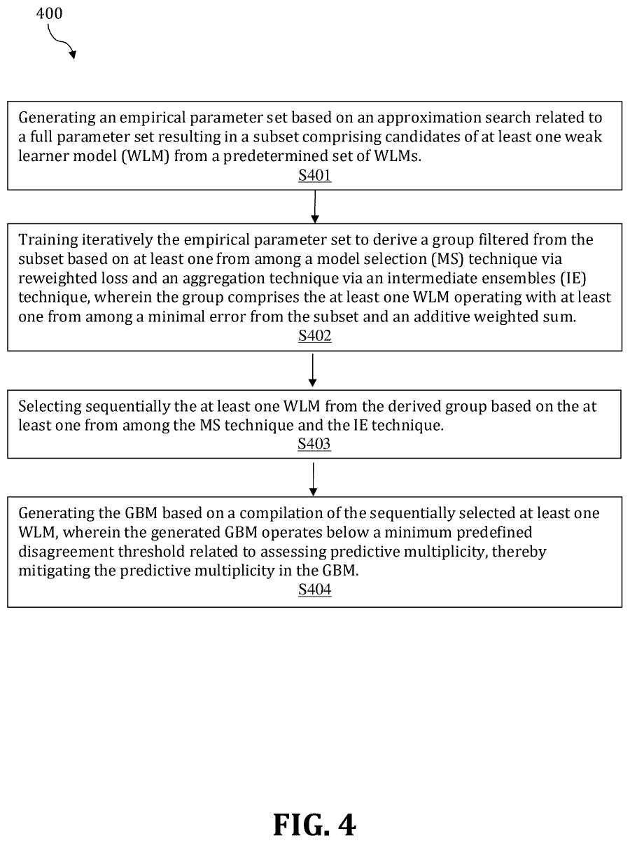

Upon being started, the mitigating predictive multiplicity in a GBM algorithm 302 executes a process implementing a method of mitigating predictive multiplicity in a GBM. A process for mitigating predictive multiplicity in a GBM may be generally indicated at flowchart 400 in FIG. 4.

FIG. 4 illustrates a flowchart of a process diagram 400 of a process for mitigating predictive multiplicity in a GBM according to an embodiment. The process diagram 400 may be implemented by the system environment 300 of FIG. 3, a network environment 200 of FIG. 2, and the system 100 of FIG. 1. At step S401 of the flowchart process 400, the computing apparatus 202 implements mitigating predictive multiplicity in a GBM algorithm 302 to generate an empirical parameter set based on an approximation search. The approximation search may be related to a full parameter set (e.g., a full Rashomon set) resulting in a subset of candidates, which may include at least one weak learner model (WLM) from a predetermined set of WLMs. That is, an approximation search may be performed to approximate the full parameter set (e.g., approximate the full Rashomon set) to generate a resulting subset of candidates, wherein the approximation search and full Rashomon set are further described below. The WLM may be a base model whose performance is above that of random guessing.

In an embodiment, the full parameter set may include a Rashomon set that may include the predetermined set of WLMs within a hypothesis space with population risks associated with that of a predefined empirical risk minimizer. The Rashomon set may be the set of all models (e.g., but not limited to WLMs) in the hypothesis space H whose population risks may be comparable to that of a given empirical risk minimizer. The Rashomon set is further described below. The empirical risk minimizer may describe a statistical supervised learning technique for a model (e.g., but not limited to, a WLM) to evaluate a performance of the model based on a specified dataset and the difference between a predicted result of the model and a known output, i.e., a loss associated with the model's performance. The empirical risk minimizer may help in the selection of a function for minimizing a risk, denoted as an empirical risk, associated with this loss. Additionally, in an embodiment, the generating empirical parameter set comprises approximating the Rashomon set with the subset from the predetermined set of WLMs within the hypothesis space, wherein the empirical parameter set may denote an empirical Rashomon set.

Consider, for example, a sample

$$S = {\{ {s}_{i} \}}_{i = 1}^{n}$$

drawn independently and identically distinct (i.i.d.) from P_{S}, wherein each sᵢ may be a pair (xᵢ, yᵢ) consisting of a feature vector xᵢ=[xᵢ₁, . . . , x_{id}]^{T} ϵX ⊂ [symbol] ^{d} and a target yᵢ ϵ [symbol] . Let X and Y be the random variables for the feature xᵢ and target yᵢ respectively, and S=X×Y. Let H denote a hypothesis space of functions that map from X to Y. The loss function used to evaluate model performance may then be denoted by [symbol] :H×S→ [symbol] + and L_{PS}(h) [symbol] [symbol] _{PS}[ [symbol] (h, S)] may denote the population risk. As usual, the population risk may be approximated by the empirical risk

$${L}_{S} ( h ) {=}^{△} 1 \frac{1}{n} {\sum }_{i = 1}^{n} ℓ ( h , {s}_{i} ) .$$

The empirical risk minimizer may be denoted as h*=argmin_{hϵH} L_{S}(h)ϵH. The representation ∇ₓv(x) may denote the gradient of v(x) with regards to x, and 1[⋅] may denote the indicator function.

The Rashomon effect may generally start with searching for models (e.g., ML models such as WLMs) in a Rashomon set, i.e., the set of all models in the hypothesis space H whose population risks may be comparable to that of a given empirical risk minimizer h*ϵH. That is:

$$ℛ ( ℋ , 𝒮 , {h}^{*} , ϵ ) {=}^{△} \{ h ∈ ℋ ; {L}_{{P}_{S}} ( h ) \leq {L}_{{P}_{S}} ( {h}^{*} ) + ϵ ) , \qquad ( 1 )$$

wherein ϵ≥0 may be a Rashomon parameter that determines the size of the Rashomon set. However, when the hypothesis space H is large (e.g., neural network architectures, tree ensembles, etc.), then exhaustively identifying all models within the Rashomon set becomes computationally infeasible.

Therefore, it may be customary to approximate the full Rashomon set by a subset with m models called an empirical Rashomon set, R^{m}(H, S, h*, ϵ){h₁, . . . , hₘϵH; hᵢ ϵR(H, S, h*, ϵ), ∀i ϵ[m]}.

In practice, the m models in the empirical Rashomon set may be obtained primarily by re-training. The re-training strategy re-trains models with different random initializations and rejects those that disobey the loss deviation constraint in Eq. (1) above until the m models are collected. However, re-training the models repeatedly may be time-consuming with large datasets or complex architectures. As such, to improve efficiency, the present application discloses two techniques associated with an empirical Rashomon set.

The Rashomon effect in ML models presents a risk to the credibility of ML models' decisions due to a concept known as predictive multiplicity, wherein competing ML models, generated by simply varying randomness in the training processes may yield conflicting predictions for some individual samples. That is, predictive multiplicity undermines the credibility of decisions made by ML models. Predictive multiplicity metrics may be categorized based on whether they are defined on output decisions (i.e., thresholded predictions/scores after argmax) or on output scores in the probability simplex. For example, ambiguity and discrepancy, measure the proportion of samples with conflicting decisions from ML models within the Rashomon set. Similarly, disagreement assesses the probability of conflicting decisions per sample. That is, one metric of predictive multiplicity may be decision-based.

Alternatively, another metric of predictive multiplicity may be score-based metrics that estimate various aspects such as score variance/standard, the viable range of scores (referred to as viable prediction range (VPR)), or score spread in the probability simplex (referred to as Rashomon Capacity (RC)). These predictive multiplicity metrics are often estimated using the empirical Rashomon set R^{m}(H, S, h*, ϵ). As m increases, the empirical Rashomon set better approximates the Rashomon set, leading to more precise estimations of predictive multiplicity metrics.

As such, mitigating predictive multiplicity is necessary to ensure that decisions made by ML models are consistent. Presently within the status quo, the main strategy to mitigate predictive multiplicity has been to combine decisions from competing ML models. Combining decisions from multiple ML models falls under the umbrella of model averaging in ensemble learning. Model averaging may be a special ensemble learning that collects multiple base models, often referred to as weak learners, and combines them in parallel. As averaging model outputs reduces the variance, model averaging may be a natural choice utilized for diminishing predictive multiplicity and has been reported in several studies. Given this description of the status quo, the description now focuses on the two techniques presented in the present application that distinguishes from and improves upon the status quo.

At step S402, the computing apparatus 202 may train iteratively the empirical parameter set to derive a group filtered from the subset based on at least one from among a model selection (MS) technique via reweighted loss and an aggregation technique via an intermediate ensembles (IE) technique. That is, the group may be filtered based on using either the MS technique with reweighted loss or an aggregation technique with IE technique. The group may include the at least one WLM operating with at least one from among a minimal error from the subset and an additive weighted sum.

In an embodiment, the MS technique includes: computing the reweighted loss for each of the at least one WLM within the subset, wherein the reweighted loss comprises a predefined loss function evaluated at a data sample for the each of the at least one WLM and evaluated at a predefined mean loss function; generating the derived group that collectively operates with a minimum error as indicated by a minimum value of the computed reweighted loss; and choosing the at least one WLM from the derived group, wherein the chosen at least one WLM individually operates with the minimum value of the computed reweighted loss as compared with other WLMs within the derived group. Although the phrase data sample may be used, other phrases such as, but not limited to, data point or data instance may also be used. The MS technique may further include: computing residuals for a next training iteration based on the chosen at least one WLM, and returning the derived group at a last gradient boosting iteration of the training iteration.

Continuing with step S402, the framework for the present application may include training m distinct ML models (e.g., WLMs) in each iteration, which offers the added benefit of reducing predictive multiplicity in gradient boosting models (GBMs). The m models in the empirical Rashomon set for

$${R}^{m} ( H , {S}_{t} , {h}_{t}^{*} , ϵ )$$

for the t^{th} iteration may either be selected (based on the least losses) or aggregated (similarly to ML model averaging as described). The MS and IE techniques build upon these concepts to reduce predictive multiplicity in gradient boosting for GBMs via: (i) model selection with reweighted loss (MS) and (ii) intermediate ensembles during boosting iterations (IE).

Let [symbol] _{i,j}= [symbol] (hⱼ, sᵢ) be the loss evaluated at sample sᵢ for model hⱼ ϵR^{m}(H, Sₜ, h*ₜ, ϵ), and let

$${\overline{ℓ}}_{ι} = \frac{1}{m} {\sum }_{j = 1}^{m} {ℓ}_{i , j}$$

be the mean loss.

The MS technique may consider the reweighted loss for each ML model (e.g., each GBM) in the empirical Rashomon set using:

$${ℓ}_{{h}_{j}} {=}^{△} {{\sum }^{n}}_{i = 1} {ℓ}_{i , j} {( \frac{{ℓ}_{i , j}}{{\overline{ℓ}}_{i}} )}^{λ} \qquad ( 2 )$$

and selects the top k models with the smallest [symbol] ₕ_{ⱼ}, where k≤m. The MS technique may simplify to re-training at λ=0. The ML model (e.g., GBM) with the smallest [symbol] ₕ_{ⱼ} may be used to compute the residuals for the next iteration, and return the top k ML models (e.g., GBMs) at the last boosting iteration. The reasoning behind this reweighting may be that the loss contribution of sample sᵢ may be rewarded at an exponential scaling factor λ≥0 when the model hⱼ produces lower loss than the average for sᵢ over all models in

$${R}^{m} ( H , {S}_{t} , {h}_{t}^{*} , ϵ ) .$$

In an embodiment, the IE technique may include: constructing at least one weighted ensemble of WLMs based on randomly selecting the at least one WLM from the subset at each of the training iterations; computing an additive weighted sum of the at least one weighted ensemble of WLM based on at least one output from the randomly selected at least one WLM; and generating the derived group based on the computed additive weighted sum.

That is, the IE technique may construct U ensembles h̅ᵤ̅, u ϵ[U] in each iteration, where each ensemble consists of E randomly selected models from

$${R}^{m} ( H , {S}_{t} , {h}_{t}^{*} , ϵ ) .$$

The model h̅ᵤ̅ may be constructed by an additive weighted sum of the outputs of the E models. That is:

$$\overline{{h}_{u}} ( {x}_{i} ) = \frac{1}{E} {\sum }_{e = 1}^{E} {ω}_{e} {h}_{e} ( {x}_{i} ) \qquad ( 3 )$$

where the weights wₑ=(1/ [symbol] ₕₑ)/w, and w is the harmonic mean of all loss

$${\{ {ℓ}_{{h}_{e}} \}}_{e = 1}^{E} .$$

At step S403, the computing apparatus 202 may select sequentially the at least one WLM from the derived group based on the at least one from among the MS technique and the IE technique., wherein the MS and IE technique are described above.

At step S404, the computing apparatus 202 may generate the GBM based on a compilation of the sequentially selected at least one WLM, wherein the generated GBM operates below a minimum predefined disagreement threshold related to assessing predictive multiplicity, thereby mitigating the predictive multiplicity in the GBM. Additionally, the iterative training may be expanded to the predetermined set of WLMs, i.e., expanded to the other WLMs within the predetermined set of WLMs.

In an embodiment, the minimum predefined disagreement threshold comprises a predefined p-disagreement function with a p value of zero. The predefined p-disagreement function may be represented by:

$$d ( 𝒮 , p ) {=}^{△} \frac{1}{n} {\sum }_{i = 1}^{n} [ μ ( {s}_{i} ) \leq p ] . \qquad ( 4 )$$

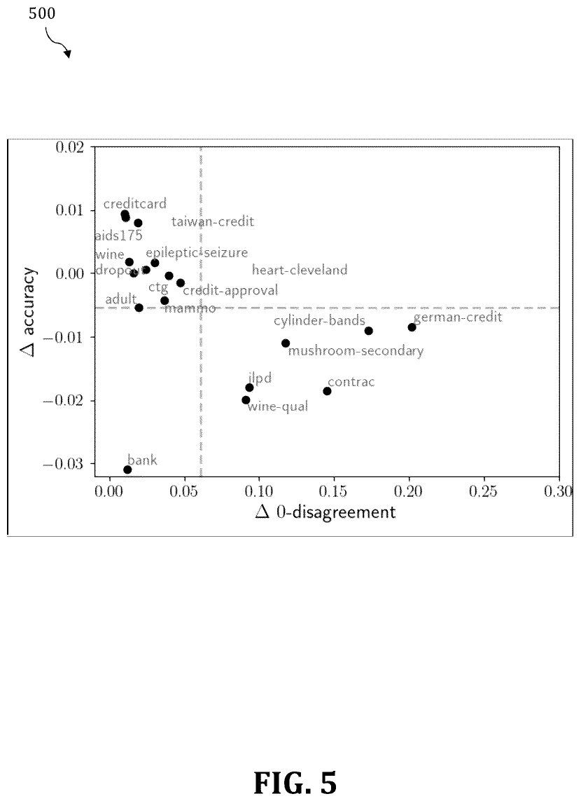

FIG. 5 illustrates an example graph of a delta-zero disagreement of mitigating predictive multiplicity in a GBM based on a model selection (MS) technique 500 according to an embodiment as described in FIG. 4. That is, the example graph is derived from an experiment involving MS technique. The dots in the graph represent the various tabular datasets used. In an example, the experiment may use twenty-one (21) tabular datasets, e.g., credit card tabular datasets, heart tabular datasets from the Cleveland Clinic, etc.

Table 1 shows the twenty-one tabular datasets. In an example, the tabular datasets may be obtained from the University of California-Irvine (UCI) machine learning (ML) repository. The descriptions of the tabular datasets, including the number of features, training/test split, and the label description have been summarized in Table 1. From the UCI ML repository, twenty-one tabular datasets were selected in specific domains, including medicine, economics, society, etc., that may possess critical consequences if predictive multiplicity is not accounted for. For these selected twenty-one tabular datasets, it was removed samples with missing values, one-hot encoded nominal features, and re-scale numeric features. Additionally, the target label name has been set to be 1 and the rest to be 0.

TABLE 1
Tabular dataset descriptions.

| | | Training | Test | |
|---|---|---|---|---|
| | # of | set | set | |
| Dataset | features | size | size | Label (# of classes) |
| ACS Income | 10 | 1331k | 332k | Income larger than |
| | | | | median or not |
| UCI Adult | 104 | 22621 | 7541 | Income >50K |
| AIDS-175 | 26 | 1283 | 856 | Patient death within |
| | | | | the study period |
| Bank | 63 | 30891 | 10297 | Has deposit |
| marketing | | | | |
| Cardio- | 84 | 1275 | 851 | Normal or not |
| tocography | | | | |
| (ctg) | | | | |
| COMPAS | 6 | 4222 | 1056 | Commit a crime again or |
| | | | | not |
| Contra- | 9 | 1104 | 369 | Long or short term |
| ception | | | | |
| Credit | 51 | 414 | 276 | Credit card application |
| approval | | | | approval or not |
| Credit card | 23 | 24000 | 6000 | Default a payment or not |
| Cylinder | 39 | 324 | 216 | Band or no band |
| bands | | | | |
| Dropout | 36 | 2654 | 1770 | Student drops out of |
| | | | | school or not |
| Epileptic | 178 | 6900 | 4600 | Subject has seizure or |
| seizure | | | | not |
| German credit | 20 | 600 | 400 | Good/bad credit risk |
| Heart disease | 13 | 181 | 122 | Absence/presence of |
| (Cleveland) | | | | heart disease |
| ILPD | 10 | 349 | 234 | Patient with/without |
| | | | | liver disease |
| Mammography | 5 | 622 | 208 | Benign or malignant |
| Mushroom | 20 | 36641 | 24428 | Poisonous or not |
| secondary | | | | |
| Qualitative | 18 | 150 | 100 | Had bankruptcy or not |
| bankruptcy | | | | |
| Taiwan credit | 23 | 18000 | 12000 | Borrower defaults on |
| | | | | payment or not |
| Wine | 13 | 106 | 72 | Wine type 2 vs. rest |
| Wine quality | 13 | 3898 | 2599 | Quality >2 |

The graph may show a re-training vs. MS technique with a predefined p-disagreement function with a p value of zero, i.e., Δ 0-disagreement. In the experiment as shown in FIG. 5, the values may be set to be: U=m=100, k=25, and E=20. For a fair comparison between the two techniques, the MS technique and IE technique share the same training procedure as re-training, i.e., in all iterations, it may be selected that the top k ML models=25 from ML models m=100 ML models. The ML models may be GBMs. Additionally, the experiment may utilize the MS technique with λ=3 to mitigate predictive multiplicity on the tabular datasets. Each point may be averaged over 20 random train-test splits (standard deviation omitted for clarity). The dashed lines denote the mean of each axis. Additionally, higher values are better for both axes.

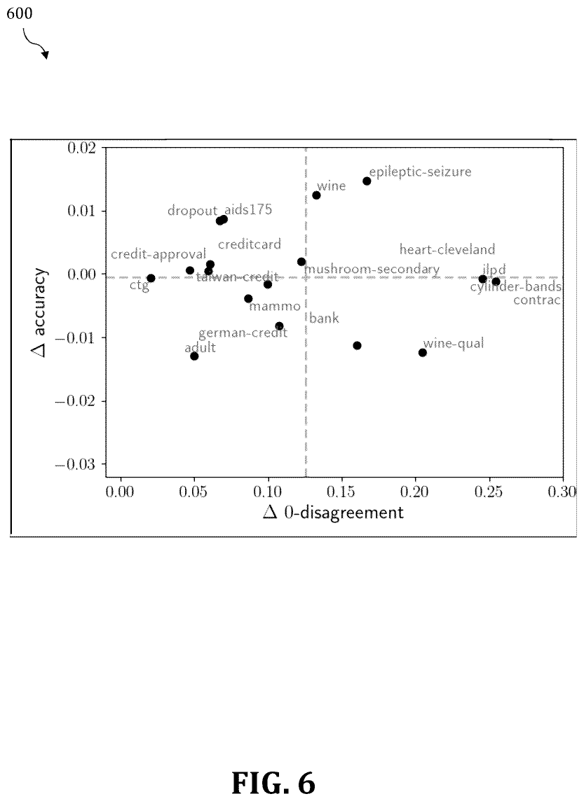

FIG. 6 shows an example graph of a delta-zero disagreement of mitigating predictive multiplicity in a gradient boosting model (GBM) based on intermediate ensembles (IE) technique 600 according to an embodiment as described in FIG. 4. The experimental setup being similar to the experimental setup as described in FIG. 5. The experiment may utilize the IE technique with E=20 to mitigate predictive multiplicity on the tabular datasets. Each point may be averaged over 20 random train-test splits (standard deviation omitted for clarity). The dashed lines denote the mean of each axis. Additionally, higher values are better for both axes. The graph in FIG. 6 may show a re-training vs. MS technique with a predefined p-disagreement function with a p value of zero, i.e., Δ 0-disagreement.

From the experiments as shown in FIGS. 5 and 6, it may be observed that the IE technique outperforms MS technique regarding the disagreement reduction while both techniques yield a similar accuracy to re-training. However, the IE technique may have the cost of increasing the overall model complexity by a factor of E=20, which may be undesirable for interpretability or auditing. It may be noteworthy that a small Δaccuracy may lead to a great reduction in disagreement. For example, in the experiment using the “epilepticseizure” tabular dataset, re-training may have a 0-disagreement of 0.208 and IE technique may reduce it to 0.041 with only a slight improvement of 0.014±0.002 in accuracy.

Regarding the experiments as performed in FIGS. 5 and 6, ablation studies may also be performed. For instance, the effect of model hyperparameters on the two measures of interest: 0-disagreement and accuracy may be studied. In an embodiment, the mean of each measure over 20 random train/test splits may be reported. Several datasets with larger Δ0-disagreement in FIGS. 5 and 6 may be evaluated. In a first example (a), varying the ensemble size E may tend to reduce disagreement on the 5 datasets evaluated. As such, E=20 may be used when using the value E within the experiments. In a second example (b), 0-disagreement increases over increasing k. As such, the k weak learners from the candidate set in ascending order of loss may be selected. That is, increasing k tends to add ML models of decreasing quality. Furthermore, the 0-disagreement measure may be strict, requiring every additional ML model to have the same prediction on the sample. In a third example (c), 0-disagreement may tend to decrease to around λ=5. As such, the parameter λϵ[0, . . . , 5] may be tuned in the experiments. Finally, it may be demonstrated that accuracy may not be sensitive to changes in any of these hyperparameters. It is noted that for the 0-disagreement, the lower value is better and more desirable.

As such, the experimental results as shown in FIGS. 5 and 6 depict example performances of the MS technique and the IE technique, enabling an evaluation and comparison between the two techniques with regards to mitigating predictive multiple in ML models, notably GBMs.

As was previously stated above, predictive multiplicity may be reduced based on various strategies such as score-based strategies and decision-based strategies, wherein a decision may be a thresholded score or a score vector after argmax. For instance, consider a binary classification with a score q, then the decision may be obtained by [symbol] [s>τ], where τ may be a threshold. For a c-class classification problem where c>2, the score may be a vector, such as q ϵΔc, and the decision may be obtained by argmax_{iϵ[c]}[q]ᵢ. Table 2 below shows examples of decision-based predictive multiplicity metrics.

TABLE 2
Decision-based predictive multiplicity metrics.

| Metrics | Definitions |
|---|---|
| Ambiguity | $α ( 𝒟 ) \vert {=}^{Δ} \frac{1}{\vert 𝒟 \vert} {\sum }_{{x}_{i} ∈ 𝒟} {max}_{{h}_{w} ∈ ℛ} [ arg max {h}_{w} ( {x}_{i} ) \neq arg max {h}_{{w}^{*}} ( {x}_{i} ) ]$ |
| Discrepancy | $δ ( 𝒟 ) {=}^{Δ} {max}_{{h}_{w} ∈ ℛ} \frac{1}{\vert 𝒟 \vert} {\sum }_{{x}_{i} ∈ 𝒟} [ arg max {h}_{w} ( {x}_{i} ) \neq arg max {h}_{{w}^{*}} ( {x}_{i} ) ]$ |
| Disagreement | $μ ( {x}_{i} ) {=}^{Δ} 2 Pr \{ arg max {h}_{w} ( {x}_{i} ) \neq arg max {h}_{w}^{′} ( {x}_{i} ) ; {h}_{w} , {h}_{w}^{′} ∈ ℛ \}$ |

Decision-based predictive multiplicity metrics essentially measure the “conflictions” of the decisions either for the whole dataset or per sample. For example, two metrics have been proposed as measurements: ambiguity and discrepancy, wherein both of these metrics measure the fraction of conflicting decisions across a dataset. Ambiguity may be the proportion of samples in a dataset that may be assigned conflicting predictions by competing classifiers in the Rashomon set. Discrepancy may be the maximum number of predictions that could change in a dataset if there is a switch between different ML models (e.g., GBMs) within the Rashomon set. More precisely, given a pre-trained ML model h_{w*}, the ambiguity α(D) and the discrepancy δ(D) may be respectively defined as shown in Table 2. Both ambiguity and discrepancy may be estimated by a mixed integer program.

Disagreement, on the other hand, may directly use the probability of the occurrence of conflicting decisions per sample instead of having to compute the empirical fraction of conflicting decision over a dataset D. The factor 2 in the definition of disagreement as shown in Table 2 ensures that μ(xᵢ) stays within the [0, 1] range for ease of interpretation.

In contrast to decision-based predictive multiplicity metrics, score-based predictive multiplicity metrics focus on the spread of the output scores. See e.g., Table 3 as shown below. The most straightforward metric may be to compute the standard deviation (std.) s(xᵢ) and the variance (var.) of the scores of a sample by all ML models in the Rashomon set. However, the score std. or var. might not capture large score spreads that concentrate on a small subset of models. As such, to precisely capture the largest possible spread of scores, a Viable Prediction Range (VPR) v(xᵢ), may be computed. The VPR may be the largest score deviation of a sample that may be achieved by the ML models in the Rashomon set. The VPR may be computed using mixed integer programs for binary classification with linear classifiers.

TABLE 3
Score-based predictive multiplicity metrics.

| Metrics | Definitions |
|---|---|
| Std./Var. of scores | $s ( {x}_{i} ) {=}^{Δ} \sqrt{{𝔼}_{{h}_{w} ∼ {P}_{ℛ}} [ {( {h}_{w} ( {x}_{i} ) - {𝔼}_{{h}_{w} ∼ {P}_{ℛ}} [ {h}_{w} ( {x}_{i} ) ] )}^{2} ]}$ |
| Viable prediction range (VPR) | $v ( {x}_{i} ) {=}^{Δ} {max}_{{h}_{w} ∈ ℛ} {h}_{w} ( {x}_{i} ) - {min}_{{h}_{w} ∈ ℛ} {h}_{w} ( {x}_{i} )$ |
| Rashomon Capacity (RC) | $c ( {x}_{i} ) {=}^{Δ} {sup}_{{P}_{ℛ}} {inf}_{q ∈ {Δ}_{c}} {𝔼}_{{h}_{w} ∼ {P}_{ℛ}} {D}_{KL} ( {h}_{w} ( {x}_{i} ) ‖ q )$ |

Continuing with Table 3, a Rashomon Capacity (RC) metric may be computed. The RC metric may be based on information theory concepts. The RC metric measures the spread of output scores for c-class classification problems in the probability simplex Ac by an analog of channel capacity. It may be noted that the infimum (inf) as defined below

$${inf}_{q ∈ {Δ}_{c}} {𝔼}_{{h}_{w} ∼ {P}_{ℛ}} {D}_{KL} ( {h}_{w} ( {x}_{i} ) ‖ q )$$

measures (in the sense of Kullback-Leibler (KL) divergence) the spread of the scores of a sample xᵢ given a distribution PR over all the models h_{w} in the Rashomon set, where the minimizing q acts as a “centroid” for the outputs of the classifiers. The supremum picks the worst-case distribution PR over all possible distributions in the Rashomon set. Additionally, an adversarial weight perturbation (AWP) may be utilized, which perturbs the weights of a pre-trained ML model such that the output scores of a sample are thrust toward all possible classes. The outputs of the perturbed models may then be used to compute RC by the Blahut-Aromoto algorithm.

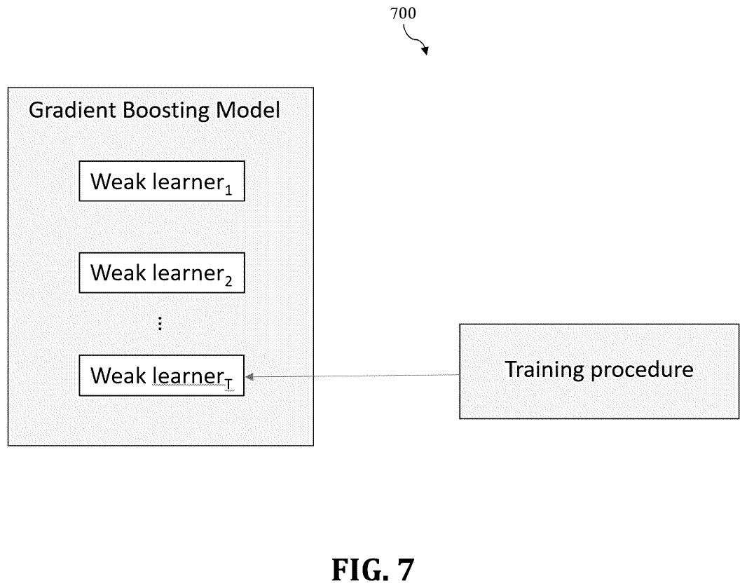

FIG. 7 illustrates an example composition of the GBM and its training procedure 700 according to an embodiment as described in FIG. 4. The GBM may consist of sequentially selected T weak learner models (WLMs). The training procedure may select a WLM at step t=1 . . . . T from a candidate set of WLMs.

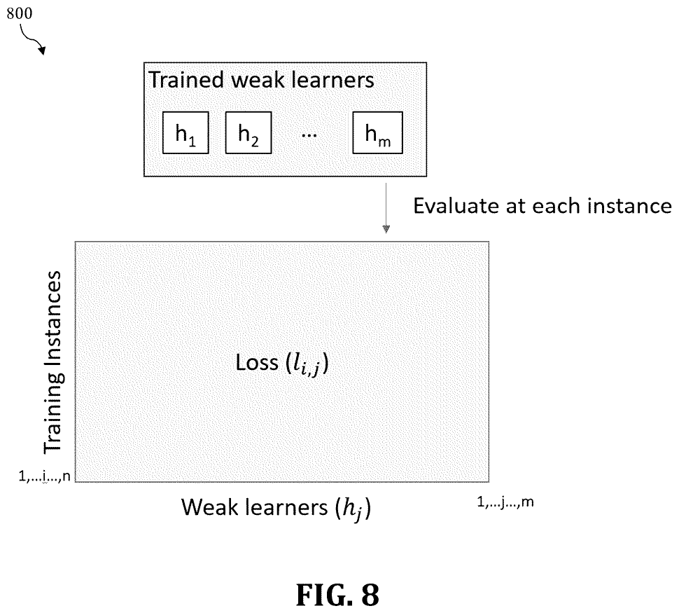

FIG. 8 illustrates an example training procedure of the WLMs involving a MS technique 800 according to an embodiment as described in FIG. 4. The process may start initially by creating a candidate set of m WLMs, ultimately generating trained WLMs. The creation may involve decision trees of fixed max-depth under varying random seed. The candidate set may be evaluated for performance over n training instances, with the evaluation being performed at each instance. Each ‘j’ candidate WLM may have a measured error (e.g., a loss) on example ‘i’.

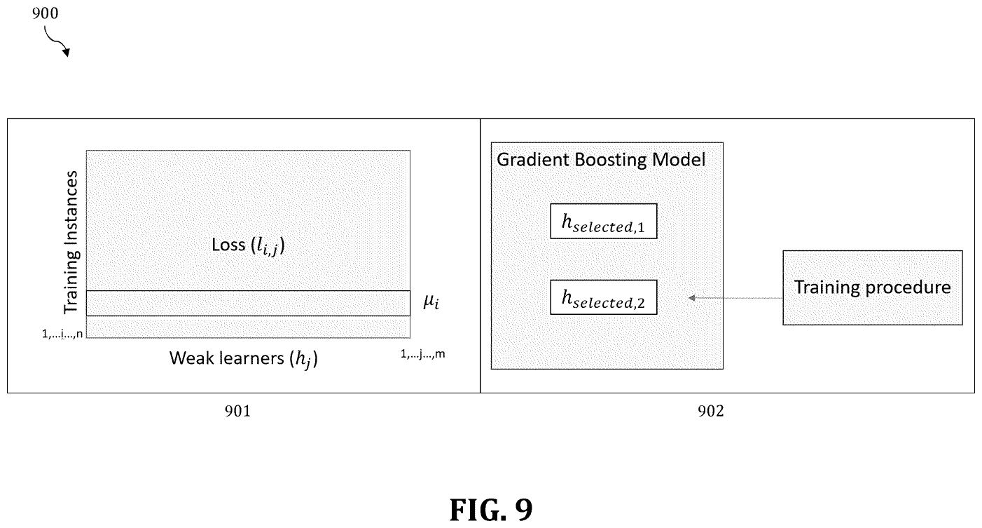

FIG. 9 illustrates a continuation of the example training procedure of the WLMs involving the MS technique 900 according to an embodiment as described in FIG. 4. The MS technique may re-weigh the lᵢⱼ loss by model hⱼ's loss vs. average loss for instance i over all WLMs (901). Continuing with 901, the MS technique may select the WLM (h_{selected}) that minimizes the loss. The equations shown below may represent the loss function for hⱼ(lₕ_{ⱼ}) and h_{selected}.

$${l}_{{h}_{j}} {=}^{△} {\sum }_{i = 1}^{n} {l}_{i , j} {( \frac{{l}_{i , j}}{{μ}_{i}} )}^{λ}$$

$${h}_{selected} = {argmin}_{j = 1 … m} ( {l}_{{h}_{j}} )$$

Continuing with FIG. 9, the h_{selected} may be returned to the GBM to compile the GBM and this process may be iterated t times (902). That is, the selected WLM, as denoted by h_{selected}, may be returned to the GBM to compile the GBM (902).

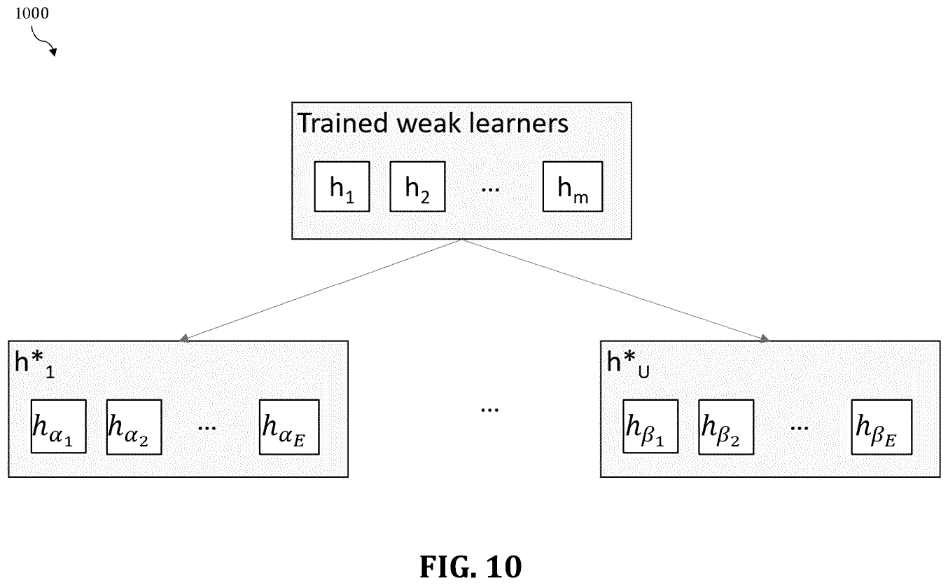

FIG. 10 illustrates an example training procedure of the WLMs involving the IE technique 1000 according to an embodiment as described in FIG. 4. The IE technique may involve a similar training procedure as that of MS technique, except that the WLMs become a weighted ensemble (i.e., combination) of WLMs, and also ultimately generates trained WLMs. In the IE technique, the WLMs may become a weighted ensemble (i.e., combination) of WLMs of size E. An ensemble may be constructed wherein U=m ensembles (i.e., equal number of ensembles as the set of WLMs may be built. The values a and B may denote random indices over 1 . . . m. The h* denotes ensembles rather than individual WLMs.

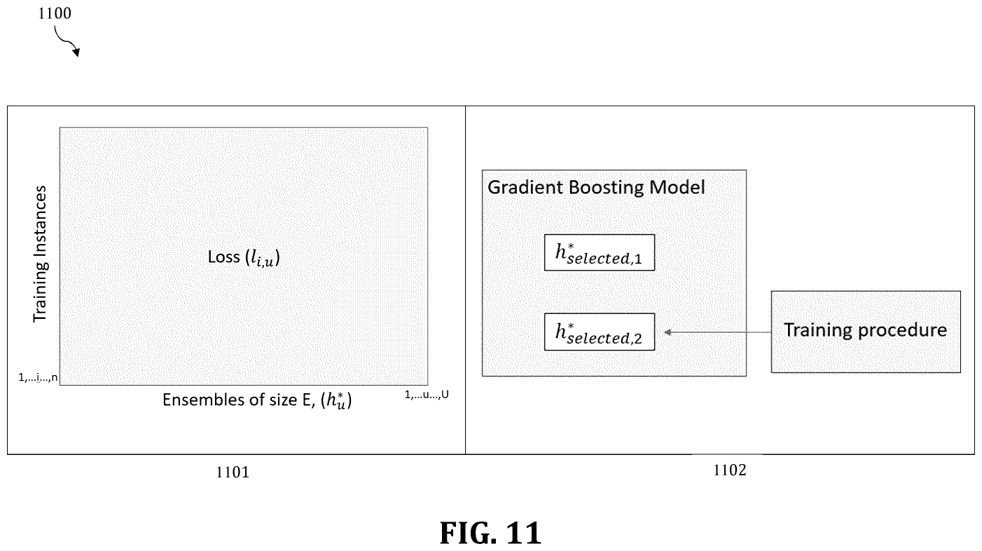

FIG. 11 illustrates a continuation of the example training procedure of the WLMs involving the IE technique 1100 according to an embodiment as described in FIG. 4. Continuing with the IE technique, after re-defining the candidate set as an ensemble of WLMs, the training procedure for the IE technique would be similar to that of the MS technique (1101). That is, the procedure between the two techniques would be then similar after this re-defining step. Again, the h* denotes ensembles rather than individual WLMs. Table 4 below shows the equations for the IE technique.

TABLE 4
Equations for the IE technique.
Weighted average of ensemble loss
${h}_{u}^{*} ( {x}_{i} ) {=}^{Δ} {\sum }_{e = 1}^{E} \frac{{h}_{e} ( {x}_{i} )}{{w}_{e}}$
Total loss over instances (since empirically, a re-weighting might not be
needed)
${l}_{{h}_{u}^{*}} = Δ {\sum }_{i = 1}^{n} {l}_{i , u}$
${h}_{s e l e c t e d}^{*} = {arg min}_{j = 1 … m} ( {l}_{{h}_{u}^{*}} )$

Continuing with FIG. 11, the h′selected may be returned to the GBM to compile the GBM and this process may be iterated t times (1102). That is, the selected WLM, as denoted by h selected, may be returned to the GBM to compile the GBM (1102). Note that this process for the IE technique may be similar to that of the MS technique as described at 902.

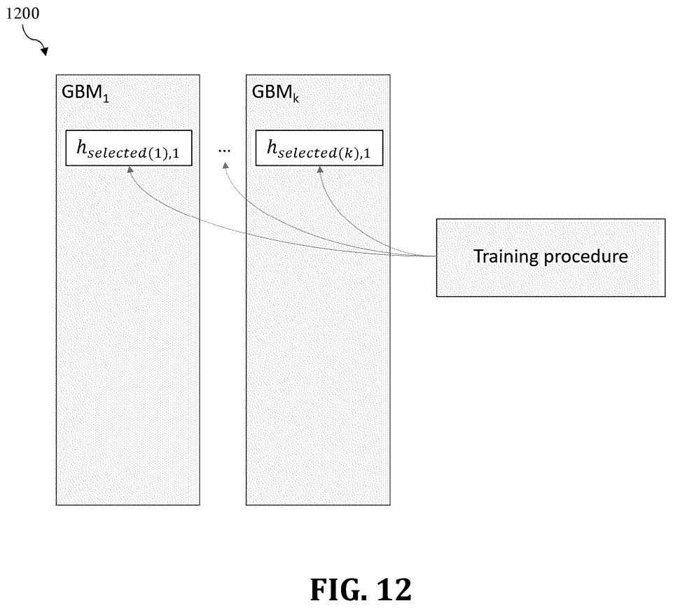

FIG. 12 illustrates an example training procedure for multiple GBMs 1200 according to an embodiment as described in FIG. 4. In an example, k>1 GBMs may be trained by returning the top-k WLMs (or ensembles of WLMs) from a boosting procedure (rather than at the argmin, top-1 step). This training process of the GBMs may be iterated t times.

Although the invention has been described with reference to several embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure may be considered to include any computer-readable medium or other equivalents and successor media, in which data or instructions may be stored.

Although the present application describes specific embodiments which may be implemented as computer programs or code segments in computer-readable media, it may be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method of mitigating predictive multiplicity in a gradient boosting model (GBM), the method being implemented by at least one processor, the method comprising:
generating an empirical parameter set based on an approximation search related to a full parameter set resulting in a subset comprising candidates of at least one weak learner model (WLM) from a predetermined set of WLMs;
training iteratively the empirical parameter set to derive a group filtered from the subset based on at least one from among a model selection (MS) technique via reweighted loss and an aggregation technique via an intermediate ensembles (IE) technique, wherein the group comprises the at least one WLM operating with at least one from among a minimal error from the subset and an additive weighted sum;
selecting sequentially the at least one WLM from the derived group based on the at least one from among the MS technique and the IE technique; and
generating the GBM based on a compilation of the sequentially selected at least one WLM, wherein the generated GBM operates below a minimum predefined disagreement threshold related to assessing predictive multiplicity, thereby mitigating the predictive multiplicity in the GBM.

2. The method of claim 1, wherein the MS technique comprises:
computing the reweighted loss for each of the at least one WLM within the subset, wherein the reweighted loss comprises a predefined loss function evaluated at a data sample for the each of the at least one WLM and evaluated at a predefined mean loss function;
generating the derived group that collectively operates with a minimum error as indicated by a minimum value of the computed reweighted loss; and
choosing the at least one WLM from the derived group, wherein the chosen at least one WLM individually operates with the minimum value of the computed reweighted loss as compared with other WLMs within the derived group.

3. The method of claim 2, wherein the MS technique further comprises:
computing residuals for a next training iteration based on the chosen at least one WLM; and
returning the derived group at a last gradient boosting iteration of the training iteration.

4. The method of claim 1, wherein the IE technique comprises:
constructing at least one weighted ensemble of WLMs based on randomly selecting the at least one WLM from the subset at each of the training iterations;
computing an additive weighted sum of the at least one weighted ensemble of WLM based on at least one output from the randomly selected at least one WLM; and
generating the derived group based on the computed additive weighted sum.

5. The method of claim 1, wherein the full parameter set comprises a Rashomon set that comprises the predetermined set of WLMs within a hypothesis space with population risks associated with that of a predefined empirical risk minimizer.

6. The method of claim 5, wherein the generating the empirical parameter set comprises approximating the Rashomon set with the subset from the predetermined set of WLMs within the hypothesis space; and
wherein the empirical parameter set denotes an empirical Rashomon set.

7. The method of claim 1, wherein the minimum predefined disagreement threshold comprises a predefined p-disagreement function with a p value of zero.

8. The method of claim 1, further comprising: expanding the iterative training to the predetermined set of WLMs.

9. A computing apparatus for mitigating predictive multiplicity in a gradient boosting model (GBM), comprising:
a processor;
a memory;
a display; and
a communication interface coupled to each of the processor, the memory, and the display, wherein the processor is configured to:
generate an empirical parameter set based on an approximation search related to a full parameter set resulting in a subset comprising candidates of at least one weak learner model (WLM) from a predetermined set of WLMs;
train iteratively the empirical parameter set to derive a group filtered from the subset based on at least one from among a model selection (MS) technique via reweighted loss and an aggregation technique via an intermediate ensembles (IE) technique, wherein the group comprises the at least one WLM operating with at least one from among a minimal error from the subset and an additive weighted sum;
select sequentially the at least one WLM from the derived group based on the at least one from among the MS technique and the IE technique; and
generate the GBM based on a compilation of the sequentially selected at least one WLM, wherein the generated GBM operates below a minimum predefined disagreement threshold related to assessing predictive multiplicity, thereby mitigating the predictive multiplicity in the GBM.

10. The computing apparatus of claim 9, wherein the MS technique comprises:
computing the reweighted loss for each of the at least one WLM within the subset, wherein the reweighted loss comprises a predefined loss function evaluated at a data sample for the each of the at least one WLM and evaluated at a predefined mean loss function;
generating the derived group that collectively operates with a minimum error as indicated by a minimum value of the computed reweighted loss; and
choosing the at least one WLM from the derived group, wherein the chosen at least one WLM individually operates with the minimum value of the computed reweighted loss as compared with other WLMs within the derived group.

11. The computing apparatus of claim 10, wherein the MS technique further comprises:
computing residuals for a next training iteration based on the chosen at least one WLM; and
returning the derived group at a last gradient boosting iteration of the training iteration.

12. The computing apparatus of claim 9, wherein the IE technique comprises:
constructing at least one weighted ensemble of WLMs based on randomly selecting the at least one WLM from the subset at each of the training iterations;
computing an additive weighted sum of the at least one weighted ensemble of WLM based on at least one output from the randomly selected at least one WLM; and
generating the derived group based on the computed additive weighted sum.

13. The computing apparatus of claim 9, wherein the full parameter set comprises a Rashomon set that comprises the predetermined set of WLMs within a hypothesis space with population risks associated with that of a predefined empirical risk minimizer;
wherein the generating the empirical parameter set comprises approximating the Rashomon set with the subset from the predetermined set of WLMs within the hypothesis space;
wherein the empirical parameter set denotes an empirical Rashomon set; and
wherein the minimum predefined disagreement threshold comprises a predefined p-disagreement function with a p value of zero.

14. The computing apparatus of claim 9, wherein the processor is further configured to expand the iterative training to the predetermined set of WLMs.

15. A non-transitory computer readable storage medium storing instructions for mitigating predictive multiplicity in a gradient boosting model (GBM), the non-transitory computer readable storage medium comprising executable code which, when executed by a processor, causes the processor to:
generate an empirical parameter set based on an approximation search related to a full parameter set resulting in a subset comprising candidates of at least one weak learner model (WLM) from a predetermined set of WLMs;
train iteratively the empirical parameter set to derive a group filtered from the subset based on at least one from among a model selection (MS) technique via reweighted loss and an aggregation technique via an intermediate ensembles (IE) technique, wherein the group comprises the at least one WLM operating with at least one from among a minimal error from the subset and an additive weighted sum;
select sequentially the at least one WLM from the derived group based on the at least one from among the MS technique and the IE technique; and
generate the GBM based on a compilation of the sequentially selected at least one WLM, wherein the generated GBM operates below a minimum predefined disagreement threshold related to assessing predictive multiplicity, thereby mitigating the predictive multiplicity in the GBM.

16. The non-transitory computer readable storage medium of claim 15, wherein the MS technique comprises:
computing the reweighted loss for each of the at least one WLM within the subset, wherein the reweighted loss comprises a predefined loss function evaluated at a data sample for the each of the at least one WLM and evaluated at a predefined mean loss function;
generating the derived group that collectively operates with a minimum error as indicated by a minimum value of the computed reweighted loss; and
choosing the at least one WLM from the derived group, wherein the chosen at least one WLM individually operates with the minimum value of the computed reweighted loss as compared with other WLMs within the derived group.

17. The non-transitory computer readable storage medium of claim 16, wherein the MS technique further comprises:
computing residuals for a next training iteration based on the chosen at least one WLM; and
returning the derived group at a last gradient boosting iteration of the training iteration.

18. The non-transitory computer readable storage medium of claim 15, wherein the IE technique comprises:
constructing at least one weighted ensemble of WLMs based on randomly selecting the at least one WLM from the subset at each of the training iterations;
computing an additive weighted sum of the at least one weighted ensemble of WLM based on at least one output from the randomly selected at least one WLM; and
generating the derived group based on the computed additive weighted sum.

19. The non-transitory computer readable storage medium of claim 15, wherein the full parameter set comprises a Rashomon set that comprises the predetermined set of WLMs within a hypothesis space with population risks associated with that of a predefined empirical risk minimizer;
wherein the generating the empirical parameter set comprises approximating the Rashomon set with the subset from the predetermined set of WLMs within the hypothesis space; and
wherein the empirical parameter set denotes an empirical Rashomon set.

20. The non-transitory computer readable storage medium of claim 15, wherein the non-transitory computer readable storage medium further causes the processor to expand the iterative training to the predetermined set of WLMs.
